(19) United States
(12) Patent Application Publication
(10) Pub. No.: US 2026/0215501 A1
(43) Pub. Date: Jul. 30, 2026

(54) AEROSOL PROVISION DEVICE

(71) Applicant: Nicoventures Trading Limited, London (GB)

(72) Inventors: Jonathon LISTER, London (GB); Jusuek LEE, London (GB); Min XU, Guangdon (CN); Yudong ZHANG, Guangdon (CN); Deng DAI, Guangdon (CN)

(21) Appl. No.: 19/147,468

(22) PCT Filed: Jan. 11, 2024
(86) PCT No.: PCT/EP2024/050623

§ 371 Date: Jul. 11, 2025

(30) Foreign Application Priority Data
Jan. 13, 2023 (CN) 202310070364.6
Feb. 28, 2023 (GB) 2302881.4
Jun. 19, 2023 (CN) 202310729312.5
Sep. 12, 2023 (GB) 2313909.0

(51) Int. Cl. A24F 40/40; H05B 3/02

(52) U.S. Cl. CPC A24F 40/40; H05B 3/02

(57) ABSTRACT

An aerosol provision device is provided. The device comprises a body having an opening and a chamber in the body arranged to receive at least a portion of an article comprising aerosol generating material inserted through the opening. The device comprises a cover mechanism comprising a cover member arranged to selectively at least partially cover the opening and an actuating member arranged to rotate on the body to actuate the cover member. Rotation of the actuating member relative to the body causes the cover member to move between a relatively open position in which the at least a portion of an article is able to pass through the opening and a relatively closed position in which the at least a portion of an article is prevented from being able to pass through the opening. The opening is offset from an axis of rotation of the actuating member.

### CROSS-REFERENCE TO RELATED APPLICATIONS

This present application is a National Phase entry of PCT Application No. PCT/EP2024/050623, filed 11 Jan. 2024, which claims priority from Chinese Application No. 202310070364.6, filed Jan. 13, 2023, and claims priority from Great Britain Application No. 2302881.4, filed Feb. 28, 2023, and claims priority from Chinese Application No. 202310729312.5, filed Jun. 19, 2023, and claims priority from Great Britain Application No. 2313909.0, filed Sep. 12, 2023, each of which are fully incorporated herein by reference in their entireties.

### TECHNICAL FIELD

The present invention relates to an aerosol provision device for generating an aerosol from aerosol-generating material. The present invention also relates to an aerosol provision system.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided an aerosol provision device comprising: a body having an opening; a chamber in the body arranged to receive at least a portion of an article comprising aerosol generating material inserted through the opening; and a cover mechanism comprising: a cover member arranged to selectively at least partially cover the opening; and an actuating member arranged to rotate on the body to actuate the cover member; wherein rotation of the actuating member relative to the body causes the cover member to move between a relatively open position in which the at least a portion of an article is able to pass through the opening and a relatively closed position in which the at least a portion of an article is prevented from being able to pass through the opening, and wherein the opening is offset from an axis of rotation of the actuating member.

In an embodiment of any of the above, the opening is radially spaced from the actuating member.

In an embodiment of any of the above, the opening is free from an overlap of the actuating member in a plane perpendicular to the axis of rotation of the actuating member.

In an embodiment of any of the above, the cover member is pivotally attached to the body.

In an embodiment of any of the above, the cover member is arranged to pivot about a pivot point radially spaced from the actuating member.

In an embodiment of any of the above, the cover mechanism comprises a cam mechanism acting between the cover member and the actuating member.

In an embodiment of any of the above, the cover member comprises a pin and the actuating member comprises a corresponding slot to define the cam mechanism.

In an embodiment of any of the above, the slot is an arcuate slot. The slot may define a partial spiral.

In an embodiment of any of the above, the actuating member comprises a peripheral wall and the cover member comprises a recess arranged to accommodate the peripheral wall.

In an embodiment of any of the above, the actuating member comprises a first arm and a second arm and the recess is between the first arm and the second arm.

In an embodiment of any of the above, the first arm is pivotally attached to the body.

In an embodiment of any of the above, the second arm is in engagement with the actuating member.

In an embodiment of any of the above, the pin is attached to the second arm. The pin may be integrally formed with the second arm.

In an embodiment of any of the above, the aerosol provision device comprises a user interface configuration on the actuating member. The actuating member may define an opening for allowing access to the user interface configuration.

In an embodiment of any of the above, the user interface configuration comprises at least one of a button, a light, a display and a touchscreen.

In an embodiment of any of the above, the cover member is arranged to selectively fully cover the opening.

In an embodiment of any of the above, the cover mechanism comprises a gear mechanism; and the actuating member is configured to cause the cover member to move between the relatively open position and the relatively closed position via the gear mechanism.

In accordance with some embodiments described herein, there is provided an aerosol provision device comprising: a body; a chamber in the body arranged to receive at least a portion of an article comprising aerosol generating material; the body having an opening communicating with the chamber; and a cover mechanism comprising: a cover member arranged to selectively at least partially cover the opening; an actuating member arranged to rotate on the body to actuate the cover member; wherein rotation of the actuating member relative to the body causes the cover member to move between a relatively open position in which the at least a portion of an article is able to pass through the opening and a relatively closed position in which the at least a portion of an article is prevented from being able to pass through the opening; and a retaining mechanism arranged to releasably retain the cover member in at least one of the relatively open position and the relatively closed position; wherein the actuating member comprises a retaining surface; wherein the retaining mechanism comprises a retaining member biased against the retaining surface and arranged to slide along the retaining surface; and wherein the retaining surface is configured to bias the cover member towards at least one of the relatively open position and the relatively closed position over at least substantially the entire range of motion of the cover member between the relatively open position and the relatively closed position.

In an embodiment of any of the above, the retaining surface is configured to bias the cover member towards at least one of the relatively open position and the relatively closed position over the entire range of motion of the cover member between the relatively open position and the relatively closed position.

In an embodiment of any of the above, the opening is radially spaced from the actuating member and the retaining member and the cover member overlap in a direction parallel to the axis of rotation of the actuating member.

In an embodiment of any of the above, the opening is radially spaced from the actuating member; the cover mechanism comprises a cam mechanism acting between the actuating member and the cover member; and the retaining member and the cam mechanism overlap in a direction parallel to the axis of rotation of the actuating member.

In an embodiment of any of the above, the opening is radially spaced from the actuating member; the cover mechanism comprises a cam mechanism acting between the actuating member and the cover member; and the retaining member is radially spaced from the cam mechanism.

In an embodiment of any of the above, the body comprises a mount received within the actuating member and the retaining member is on or in the mount.

In accordance with some embodiments described herein, there is provided an aerosol provision device comprising: a body; a chamber in the body arranged to receive at least a portion of an article comprising aerosol generating material; the body having an opening communicating with the chamber; and a cover mechanism comprising: a cover member arranged to selectively at least partially cover the opening; an actuating member arranged to rotate on the body to actuate the cover member; wherein rotation of the actuating member relative to the body causes the cover member to move between a relatively open position in which the at least a portion of an article is able to pass through the opening and a relatively closed position in which the at least a portion of an article is prevented from being able to pass through the opening; and a retaining mechanism arranged to releasably retain the cover member in at least one of the relatively open position and the relatively closed position; wherein the actuating member defines a channel; wherein the retaining mechanism comprises a retaining member arranged to travel at least partially in the channel as the actuating member is moved, the retaining member being biased relative to the channel; and wherein the channel is configured to bias the cover member towards at least one of the relatively open position and the relatively closed position over at least part of the range of motion of the cover member between the relatively open position and the relatively closed position.

In an embodiment of any of the above, the actuating member defines a first edge of the channel and a second edge of the channel and the retaining member is arranged to abut the first edge and the second edge.

In an embodiment of any of the above, the first edge and the second edge diverge or converge towards an end of the channel.

In an embodiment of any of the above, the first edge and the second edge converge towards an end of the channel.

In an embodiment of any of the above, the first edge and the second edge converge or diverge towards a mid-region of the channel.

In an embodiment of any of the above, the first edge and the second edge converge towards a mid-region of the channel.

In an embodiment of any of the above, the first edge and the second edge diverge towards a first end and a second end of the channel.

In an embodiment of any of the above, the actuating member comprises a part-cylindrical surface coaxial with the axis of rotation of the actuating member and the channel is defined in the part-cylindrical surface.

In an embodiment of any of the above, the opening is radially spaced from the actuating member and the retaining member and the cover member overlap in a direction parallel to the axis of rotation of the actuating member.

In an embodiment of any of the above, the opening is radially spaced from the actuating member; the actuating member and the cover member define a cam mechanism therebetween; and the retaining member and the cam mechanism overlap in a direction parallel to the axis of rotation of the actuating member.

In an embodiment of any of the above, the opening is radially spaced from the actuating member; the actuating member and the cover member define a cam mechanism therebetween; and the retaining member is radially spaced from the cam mechanism.

In an embodiment of any of the above, the body comprises an actuating member mount received within the actuating member and the retaining member is joined to the actuating member mount.

In accordance with some embodiments described herein, there is provided an aerosol provision device comprising: a body defining an opening; a heating zone arranged to receive at least a portion of an article comprising aerosol generating material inserted through the opening; and a cover mechanism comprising: a cover member arranged to selectively at least partially cover the opening; an actuating member arranged to rotate on the body to actuate the cover member; wherein rotation of the actuating member relative to the body causes the cover member to move between a relatively open position in which the at least a portion of an article is able to pass through the opening and a relatively closed position in which the at least a portion of an article is prevented from being able to pass through the opening; and a retaining mechanism arranged to releasably retain the cover member in at least one of the relatively open position and the relatively closed position; wherein the actuating member comprises a retaining surface; wherein the retaining mechanism comprises a retaining member biased in a direction parallel to the axis of rotation of the actuating member against the retaining surface and arranged to slide along the retaining surface; and wherein the retaining surface is configured to bias the cover member towards at least one of the relatively open position and the relatively closed position.

In an embodiment of any of the above, the retaining member is in a fixed relationship with the body.

In an embodiment of any of the above, the retaining surface is in a fixed relationship with the actuating member.

In an embodiment of any of the above, the cover member is a first cover member and the cover mechanism comprises a second cover member arranged to selectively at least partially cover the opening in co-operation with the first cover member, wherein rotation of the actuating member relative to the body causes the second cover member to move between a relatively open position in which the at least a portion of an article is able to pass through the opening and a relatively closed position in which the at least a portion of an article is prevented from being able to pass through the opening

In an embodiment of any of the above, the cover mechanism comprises one or more linking members pivotally attached to the or each cover member respectively and pivotally attached to the actuating member.

In an embodiment of any of the above, the cover mechanism comprises a cam mechanism acting between the cover member and the actuating member.

In an embodiment of any of the above, the cover member comprises a pin and the actuating member comprises a corresponding slot to define the cam mechanism.

In an embodiment of any of the above, the actuating member defines a channel; the retaining member is arranged to travel at least partially in the channel as the actuating member is moved, the retaining member being biased relative to the channel; and wherein the channel is configured to bias the cover member towards at least one of the relatively open position and the relatively closed position over at least part of the range of motion of the cover member between the relatively open position and the relatively closed position.

In an embodiment of any of the above, the actuating member defines a first edge of the channel and a second edge of the channel and the retaining member is arranged to abut the first edge and the second edge.

In an embodiment of any of the above, the first edge and the second edge diverge towards an end of the channel and converge towards a mid-region of the channel.

In an embodiment of any of the above, the channel follows a part circular path. In accordance with some embodiments described herein, there is provided an aerosol provision system comprising the aerosol provision device of any of the preceding and an article comprising aerosol generating material.

### BRIEF DESCRIPTION OF THE DRAWINGS

Embodiments of the invention will now be described, by way of example only, with reference to accompanying drawings, in which: FIG. 1 shows a front view of an aerosol provision device;

FIG. 2 shows a schematic cross-sectional side view of the aerosol provision device of FIG. 1;

FIG. 3 shows an exploded perspective view of a cover mechanism for the aerosol provision device of FIG. 1;

FIG. 4 shows a part cut-away plan view of the cover mechanism of FIG. 3 in an open position;

FIG. 5 shows a part cut-away plan view of the cover mechanism of FIG. 3 in a closed position

FIG. 6 shows a perspective view of an inner actuating component for the cover mechanism of FIGS. 3 to 5;

FIG. 7 shows a schematic perspective view of another cover mechanism in a closed position; and

FIG. 8 shows a schematic perspective view from below of an actuating member for the cover mechanism of FIG. 7.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavourants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilise the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

FIG. 1 shows an aerosol provision device 100 for generating aerosol from an aerosol generating material. In broad outline, the device 100 may be used to heat a replaceable article 300 comprising the aerosol generating material, to generate an aerosol or other inhalable medium which is inhaled by a user of the device 100. The article 300 and the device 100 together form an aerosol provision system 10.

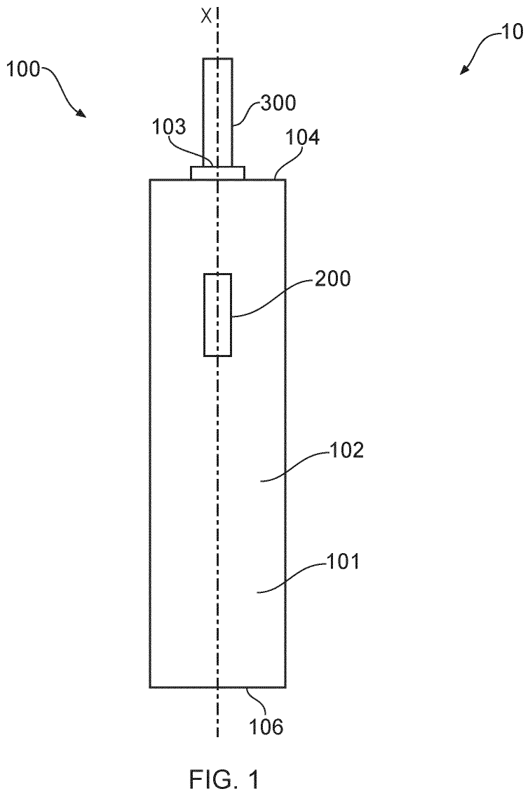

The device 100 comprises a main body 101. The main body 101 comprises a chamber 105 (refer to FIG. 2). A housing 102 surrounds and houses various components of the main body 101. An opening 103 is formed at one end of the main body 101, communicating with the chamber 105. The article 300 may be at least partially inserted through the opening 103 into the chamber 105 for heating by an aerosol generator 150 (refer to FIG. 2). In use, the article 300 may be heated by one or more components of the aerosol generator 150.

The device 100 also includes a button assembly 200, which operates the device 100 when pressed. For example, a user may turn on the device 100 by operating the button assembly 200. The button assembly 200 may be assembled as part of the other assemblies of the aerosol provision device 100.

The aerosol generator 150 defines a longitudinal axis X.

FIG. 2 shows a schematic cross-sectional view of the device 100. The device 100 comprises an electrical component, such as a connector/port 160, which can receive a cable to charge the device 100. For example, the connector 160 may be a charging port, such as a USB charging port. In some examples the connector 160 may be used additionally or alternatively to transfer data between the device 100 and another device, such as a computing device.

The device 100 comprises a power source 170, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the aerosol generator 150 to supply electrical power when required and under control of a controller to heat the aerosol generating material.

The device 100 comprises an electronics module 112. The electronics module 112 may comprise, for example, a printed circuit board (PCB). The PCB may support at least one controller, such as a processor, and memory. The PCB may also comprise one or more electrical tracks to electrically connect together various electronic components of the device 100. For example, the battery terminals may be electrically connected to the PCB so that power can be distributed throughout the device 100.

The main body 101 defines ends of the device 100. The end of the device 100 closest to the opening 103 may be known as the proximal end (or mouth end) 104 of the device 100 because, in use, it is closest to the mouth of the user. In use, a user inserts an article 300 into the opening 103, operates the aerosol generator 150 to begin heating the aerosol generating material and draws on the aerosol generated in the device. This causes the aerosol to flow through the device 100 along a flow path towards the proximal end of the device 100.

The other end of the device furthest away from the aperture 103 may be known as the distal end 106 of the device 100 because, in use, it is the end furthest away from the mouth of the user. As a user draws on the aerosol generated in the device 100, the aerosol flows in a direction towards the proximal end of the device 100. The terms proximal and distal as applied to features of the device 100 will be described by reference to the relative positioning of such features with respect to each other in a proximal-distal direction along the longitudinal axis.

As used herein, the term one-piece component refers to a component of the device 100 which is not separable into two or more components following assembly of the device 100. Integrally formed relates to two or more features that are formed into a one piece component during a manufacturing stage of the component.

An air flow passage 180 extends through the main body 101. The airflow passage 180 extends to an air inlet 190. Other airflow arrangements are envisaged. For example, airflow may be provided between a receptacle defining the chamber 105 and the article 300.

In one example, the aerosol generator 150 comprises an induction-type heating system, including a magnetic field generator. The magnetic field generator comprises an inductor coil assembly. The aerosol generator 150 comprises a heating element. The heating element is also known as a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

The aerosol generator 150 is an inductive heating assembly and comprises various components to heat the aerosol generating material of the article 300 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The inductor coil assembly includes an inductor coil. In embodiments, the number of inductor coils differs. In embodiments, a two or more inductor coils are used. The inductor coil assembly also comprises a coil support. The coil support is tubular.

The heating element is part of a heating assembly. The heating element of this example is hollow and therefore defines at least part of a receptacle within which aerosol generating material is received. For example, the article 300 can be inserted into the heating element. The heating element is tubular, with a circular cross section. The heating element has a generally constant diameter along its axial length.

In embodiments, the heating assembly defines the receptacle and the heating element upstands in the receptacle. The heating element may comprise a pin or blade arranged to penetrate the consumable. In embodiments, the consumable comprises the heating element and the aerosol provision device comprises an inductor coil arranged to inductively heat the heating element in the consumable.

The heating element is formed from an electrically conducting material suitable for heating by electromagnetic induction. The susceptor in the present example is formed from a carbon steel. It will be understood that other suitable materials may be used, for example a ferromagnetic material such as iron, nickel or cobalt.

In other embodiments, the feature acting as the heating element may not be limited to being inductively heated. The feature, acting as a heating element, may therefore be heatable by electrical resistance. The aerosol generator 150 may therefore comprise electrical contacts for electrical connection with the apparatus for electrically activating the heating element by passing a flow of electrical energy through the heating element.

The receptacle and article 300 are dimensioned so that the article 300 is received by the heating element. This helps ensure that the heating is most efficient. The article 300 of this example comprises aerosol generating material. The aerosol generating material is positioned within the receptacle. The article 300 may also comprise other components such as a filter, wrapping materials and/or a cooling structure.

The air flow passage 180 extends from the receptacle. The air flow passage 180 is at the distal end. The air flow passage 180 protrudes from the heating element. The air flow passage 180 extending from the heating element is defined by a flow path member 182. The heating element 220 and the flow path member 182 forms part of an airflow path arrangement 181.

The flow path member 182 extends between the heating element and the opening 190. The flow path member 182 is tubular. The flow path member 182 defines a bore. The flow path member extends in an axial direction along its length.

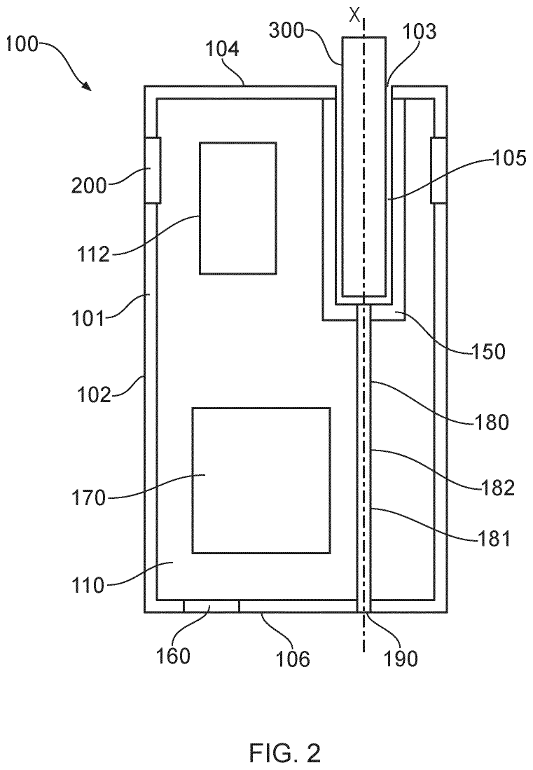

FIG. 3 shows an exploded perspective view of a cover assembly 400 for an aerosol provision device. The cover assembly 400 may be used with the aerosol provision device 100 of FIGS. 1 and 2 and will be described by reference to that device. In embodiments, the cover assembly 400 is used with other device arrangements. The cover assembly 400 comprises a cover mechanism 401.

The cover assembly 400 comprises a body 402. The body 402 is a portion of the main body 101 of the aerosol provision device 100. The body 402 is a rigid member. The body 402 defines part of the housing 102. A seal 405 is provided between the body 402 and other components of the housing 102 of the aerosol provision device 100. The seal 405 extends around a full peripheral extent of the body 402. In other embodiments, the body 402 may be integrally formed with other components of the housing 102. The body 402 defines the proximal end of the device 100.

The body 402 defines the opening 103 of the aerosol provision device 100. The opening 404 communicates with the chamber 105. The opening 404 is dimensioned to receive at least a portion of an article comprising aerosol generating material, such as the article 300.

The body 402 has an outer side 407. The outer side 407 of the body 402 includes a recess 407a. An aperture 408 is defined in the recess 407a.

The cover mechanism 401 of the cover assembly 400 comprises a cover member 410 arranged to selectively cover the opening 404. An actuating member 420 is provided to selectively actuate the cover member 410. The cover member 410 slidably contacts the body 402. The cover member 410 is substantially planar. The cover member 410 comprises a blade portion 412 arranged to cover the opening. The cover member 410 comprises a first arm portion 414. The first arm portion 414 extends from the blade portion 420. The cover member 410 comprises a second arm portion 415. The second arm portion 415 extends from the blade portion 412. A recess 416 is defined between the first arm portion 414 and the second arm portion 415.

The cover member 410 comprises a lower pivot pin 411, acting as a pivot member. The lower pivot pin 411 extends from the first arm portion 414. The lower pivot pin 411 is spaced from the blade portion 420. The cover member 410 comprises an upper pivot pin 413 acting as a pivot member. One of the upper and lower pivot pins 411 413 may be omitted. The upper pivot pin 413 extends from the first arm portion 414. The upper pivot pin 413 is spaced from the blade portion 420. The upper pivot pin 413 extends from an opposite side of the first arm portion 414 to the lower pivot pin 411. The upper pivot pin 413 and lower pivot pin 411 are co-axial. The upper pivot pin 413 and lower pivot pin 411 extend in the longitudinal axial direction.

The cover member 410 is a one-piece component. The cover member 410 is integrally formed. In other embodiments, the cover member 410 may be a composite component formed of multiple parts. For example, the upper pivot pin 413 and the lower pivot pin 411 may be a single pin extending through the first arm portion 414.

The cover mechanism 401 comprises a cam mechanism 419 configured to drive the cover member 410 in response to action of the actuating member 420. The cam mechanism 419 acts as a drive mechanism. The cam mechanism 419 comprises a cam element 418 and corresponding cam slot 434.

The cover member 410 comprises the cam element 418. The cam element 418 comprises a protrusion. The cam element 418 comprises a pin. In embodiments, the cam element 418 comprises any suitable formation for forming part of a cam mechanism. The cam element 418 is disposed on the second arm portion 415. The cam element 418 upstands from the cover member 410. The cam element 418 extends in the longitudinal axial direction.

The cover member 410 is received in the recess 407a in the body 402. The recess 407a allows the cover member 410 to be accommodated by the body 402 in a spatially efficient manner and impedes exit of debris from the chamber 105.

The body 402 comprises an upper body member 409. The upper body member 409 defines an opening 409a. The upper body member 409 comprises an annular member 448 surrounding the opening 409a. In embodiments, the annular member 448 may be omitted. The upper body member 409 is mounted with a lower body member of the body 402 such that the opening 409a is aligned with the opening 404.

The upper body member 409 comprises an aperture 417 for receiving the upper pivot pin 413 of the cover member 410.

The upper pivot pin 413 is received in the aperture 417 of the upper body member 409. The lower pivot pin 411 is received in the aperture 408 of the body 402. The cover member 410 is pivotably retained between the upper body member 409 and the lower body member of the body 402. This provides a robust cover assembly, as the cover member 410 may be securely held between two fixed components. The cover member may pivot about an axis defined by the upper pivot pin 413 and lower pivot pin 411.

The cover mechanism 400 comprises the actuating member 420. The actuating member 420 is a substantially annular member. The actuating member is rotatably mounted.

The actuating member 420 defines an aperture 422. The aperture 422 is centrally disposed in the actuating member 420. The aperture 422 may be omitted.

The actuating member 420 is arranged to rotate on the body 402 to actuate the cover member 410. The actuating member 420 covers part of the body 402. That is, a portion of the body 402 extends in the actuating member 420. The axis of rotation of the actuating member 420 is parallel with the longitudinal axis of the chamber 105. In embodiments, the axis of rotation is transverse or perpendicular.

The axis of rotation of the actuating member 420 is spaced from the longitudinal axis of the chamber 105 in a direction perpendicular to the longitudinal axis of the chamber 105. The opening 103 is spaced from the actuating member 420. The opening 103 is spaced from the actuating member 420 in a radial direction relative to the axis of rotation of the actuating member 420. The opening 103 does not overlap the actuating member 420 in a plane perpendicular to the axis of rotation of the actuating member 420.

The above configuration aids with providing a more compact arrangement of the cover assembly 400, relative to arrangements in which the axis of rotation of the actuating member 420 is aligned with the longitudinal axis of the chamber 105 or in which the opening 103 overlaps with or is disposed below the cover member 420. The actuating member 420 may accommodate other components of the cover assembly 400 without obstructing the opening 103, allowing those components to be provided in the plane of the actuating member 420. This may decrease the size of the cover assembly 400 in the axial direction of the aerosol provision device 100. For example, at least one of a retaining mechanism 450 and a user interface configuration 470, as described below, may be provided within the actuating member 420.

The aerosol provision device 100 comprises a user interface configuration 470. The user interface configuration 470 is on the actuating member 420. The actuating member 420 defines an aperture 422. The user interface configuration 470 is disposed in the aperture 422 of the actuating member 420. In embodiments, the user interface configuration 470 extends above the aperture 422 of the actuating member 420. In embodiments, electrical connections of the user interface configuration 470 extend through the aperture 422 to the main body 101 of the aerosol provision device 100. The user interface configuration 470 may comprise at least one of a button, a touchscreen, a display and an indicator light such as an LED. The user interface configuration 470 may provide at least one of an indication of the operating state of the device 100 and control of an operating state of the device 400.

The user interface configuration 470 comprises a transparent protective plate 472. The transparent protective plate 472 may be omitted.

The actuating member 420 comprises an outer actuating component 424 and an inner actuating component 426. The outer actuating component 424 is rotationally fixed to the inner actuating component 426. The outer actuating component 424 surrounds the inner actuating component 426. The outer actuating component 424 partially defines an exterior surface of the aerosol provision device 100. The outer actuating component 424 is a cylindrical body. The outer actuating component 424 forms a peripheral wall 425 around the inner actuating component 426. In embodiments, the outer and inner actuating components 424, 426 are an integral component.

The outer actuating component 424 comprises a cut-out 446. The cut-out 446 is in the peripheral wall 425. The cut-out 446 accommodates the cover member 410.

The actuating member 420 defines an elongate cam surface 433. The elongate cam surface 433 is arcuate. The elongate cam surface 433 is defined by a cam slot 434. The cam slot 434 is formed by the inner actuating component 426. The cam slot 434 is a blind slot. That is, the cam slot 434 is closed at each end. The closed ends, in embodiments, act as movement limiters. The cam slot 434 defines a partial spiral path about the axis of rotation of the actuating member 420. That is, the cam slot 434 extends partly away from the axis of rotation of the actuating member 420 in a radial direction. The cam element 418 of the cover member 410 is received in the cam slot 434. The cam element 418 and the cam slot 434 together define the cam mechanism 419.

The inner and outer actuating components 424, 426 are formed of different materials. The inner actuating component 426 is formed of a relatively hard-wearing material. The inner actuating component 426 is formed of a relatively low friction material. The inner actuating component 426 is resilient. Advantageously, this arrangement minimizes wear on the inner actuating component and reduces friction in the cover mechanism 401, while allowing the material of the outer actuating component 426 to be freely chosen to have properties suitable for an exterior surface of the aerosol provision device 100.

The body 402 comprises an actuating member mount 442. The actuating member 420 is rotatably engaged with the actuating member mount 442. The actuating member mount 442 substantially limits movement of the actuating member 420 relative to the body to rotational movement. The actuating member 420 comprises a locating feature (not shown) in engagement with the actuating member mount 442. The locating feature is a ridge or other suitable feature circumferentially extending around an inner surface of the actuating member 420. The actuating member mount 442 is spaced from the aperture 408 of the body 402 which receives the lower pivot pin 411. The actuating member 420, when mounted on the actuating member mount 442, is radially spaced from the aperture 408. In this context, radially is with reference to the axis of rotation of the actuating member 420. The cover member 410 therefore pivots about a point external to the actuating member 420.

The actuating member mount 442 comprises a clip 443 acting as a retention arrangement. The clip 443 is resilient. In this embodiment, the actuating member mount 442 comprises four clips 443. The body 402 comprises a recess 444 behind the clip. In this embodiment, the body 402 comprises a recess 444 behind each clip. The recesses 444 provide clearance to accommodate inwards radial deflection of the clips, allowing a more compact arrangement.

The cover member 410 is partially disposed between the body 402 and the actuating member 420. The cover member 410 is in sliding contact with the body 402. The cover member 410 is in sliding contact with the actuating member 420. Such an arrangement helps restrict ingress of debris.

Rotation of the actuating member 420 relative to the body 402 causes the cover member 410 to translate between a relatively open and a relatively closed position. The cover assembly 400 is configured to be selectively operated between a relatively open and a relatively closed position. Such positions are relative to each other. In the relatively open position, at least a portion of the article 300 is able to pass through the opening 404. In the relatively closed position, the at least a portion of the article 300 is prevented from being able to pass through the opening 404.

The term relatively open position will be understood to mean any position in which at least a portion of the article 300 is able to pass through the opening, i.e. including a fully open position and intermediate positions which leave enough space for the portion of the article 300 to be inserted. The term relatively closed position will be understood to mean any position in which the portion of the article 300 is prevented from being able to pass through the opening 404, i.e. including a fully closed position and intermediate positions in which there is not enough space for the article 300 to pass through the opening. In this embodiment, rotation of the actuating member 420 relative to the body 402 causes the cover member 410 to translate to or from a fully closed position. The term fully closed position will be understood to mean that the cover member 410 fully closes the opening 404. The terms open and closed as applied to features of the cover mechanism 401 are herein described in relation to one another.

The cover member 410 is arranged to pivot relative to the body 402. The cover member 410 is arranged to pivot in a direction perpendicular to an axis of rotation of the actuating member 420. The axis of rotation of the actuating member 420 is parallel with a longitudinal axis of the chamber. The axis of rotation of the actuating member 420 is offset from the longitudinal axis of the chamber. As the actuating member 420 is rotated by the user, the arcuate cam surface acts on the cam element 418, causing the cover member 410 to move. As the cam element 418 travels in the cam slot 434, the cam element 418 is driven further from or closer to the axis of rotation of the actuating member 420, depending on the direction of rotation of the actuating member 420. As the cover member 410 moves, the upper pivot pin 413 and the lower pivot pin 411 rotate in the aperture 417 of the upper body member 409 and the aperture 408 of the body 402 respectively.

In the relatively closed position, the peripheral wall of the actuating member 420 is accommodated in the recess 416 of the cover member 410. This allows the cut-out 446 of the actuating member 420 to be minimized. The cover mechanism 401 may therefore be arranged such that the cut-out 446 is free from exposure to the exterior of the aerosol provision device 100 in either the fully open position or the fully closed position, reducing the likelihood of debris entering the cover mechanism 401 via the cut-out 446, which may lead to jamming or increased wear.

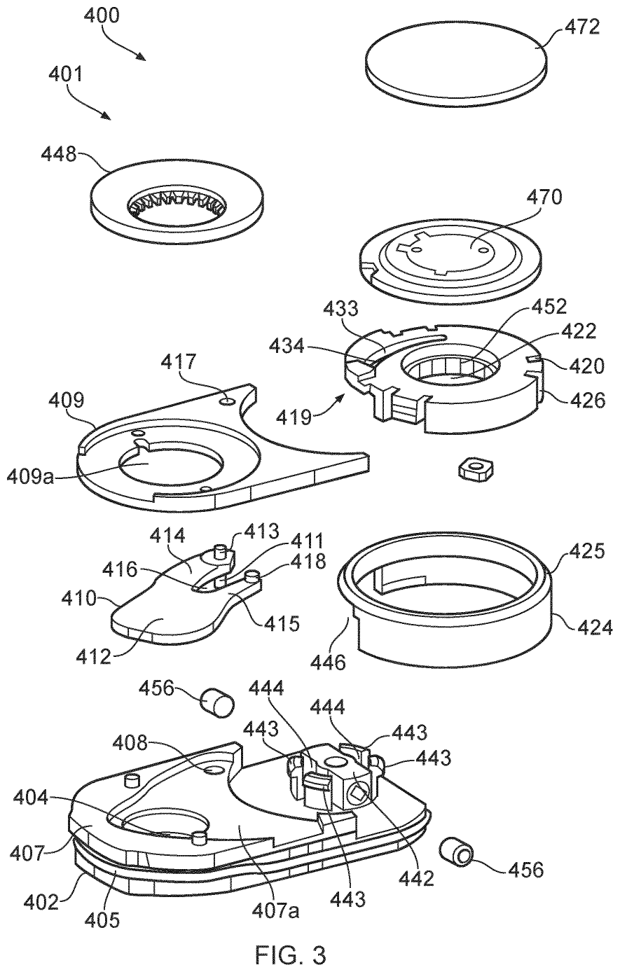

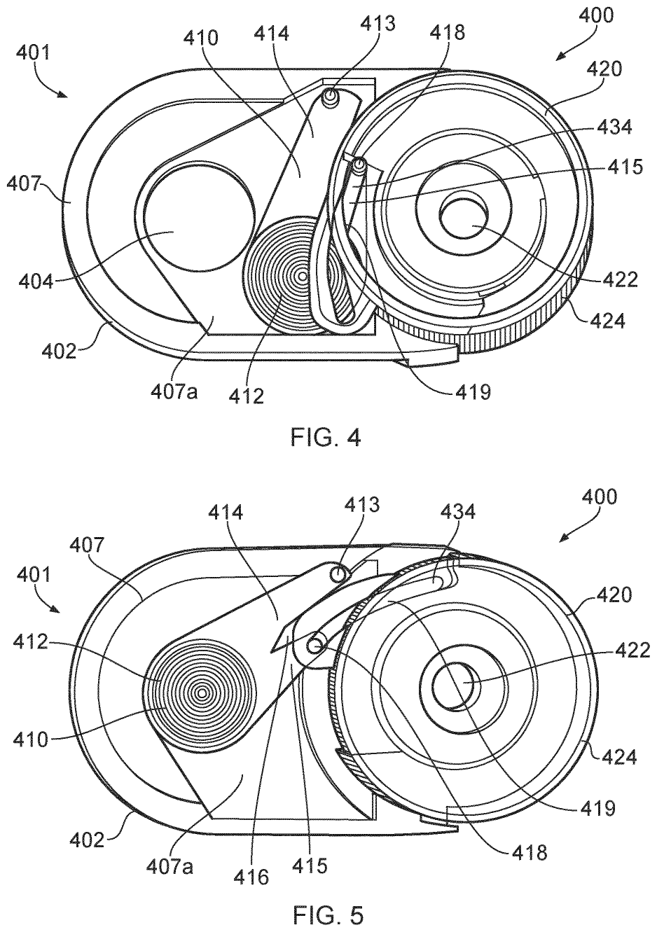

FIG. 4 shows the cover mechanism 401 in an open position and FIG. 5 shows the cover mechanism 401 in a closed position. The cover member 410 is movable between the open position as shown in FIG. 4 and the closed position as shown in FIG. 5. Rotating the actuating member 420 clockwise, as shown in the Figures, causes the cover member 410 to move towards the closed position. Rotating the actuating member 420 counter clockwise, as shown in the Figures, causes the cover member 410 to move towards the open position. In other embodiments, these directions may be reversed.

In the relatively open position, part of cover member 410 is received in the cut-out 446 of the actuating member 420. The first arm portion 414 of the cover member 410 spaces the blade portion 412 of the cover member 410 from the pivot axis of the cover member 410. The second arm portion 415 of the cover member 410 spaces the blade portion 412 of the cover member 410 from the cam mechanism. This enables a small movement of the actuating member 420 to move the blade portion 412 through a range of motion large enough to fully traverse the opening 404.

In embodiments, the cover mechanism 401 comprises a lubricant.

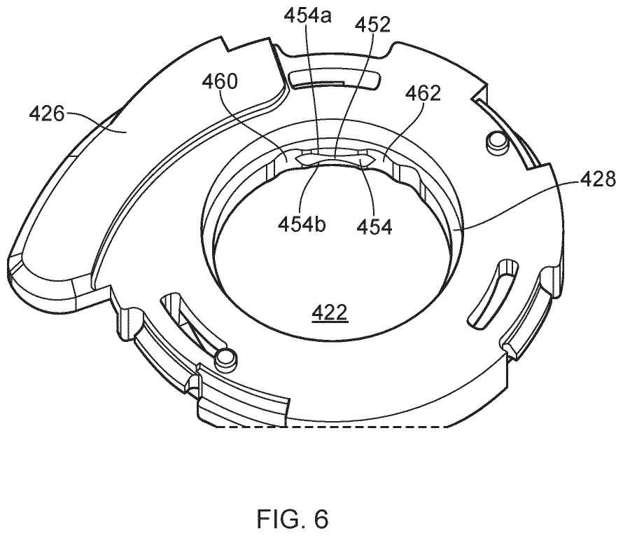

FIG. 6 shows a perspective view from above of the inner actuating component 426. The inner actuating component 426 comprises the aperture 422. The aperture 422 is configured to receive the actuating member mount 442 of the body 402. The inner actuating component 426 is slidably engaged with the actuating member mount 442. The aperture 422 is substantially circular.

The aperture 422 is partly defined by a shoulder 428 of the inner actuating component 426. The shoulder 428 is circumferential. The shoulder 428 extends around substantially the entire circumference of the inner actuating component 426. The shoulder 428 of the inner actuating component 426 is arranged to be slidably engaged by the clips 443 of the body 402. As the inner actuating component 426 rotates on the body 402, the clips 443 slide along the shoulder 428. The engagement of the clips 443 with the shoulder 428 restrains axial movement of the inner actuating component 426. The shoulder 428 provides a locating feature in engagement with the actuating member mount 442.

Referring to FIGS. 3 and 6, the cover assembly 400 comprises a retaining mechanism 450. The retaining mechanism 450 is arranged to releasably retain the actuating member 420 in each of the open position and the closed position. In embodiments, the retaining mechanism 450 is arranged to act in one of the open and closed position only.

The actuating member 420 comprises a retaining surface 452. The retaining surface 452 is defined by the inner actuating component 426. The retaining mechanism 450 comprises an open position recess 460 and a closed position recess 462. The recesses 460, 462 are defined by the retaining surface 452.

The retaining mechanism 450 comprises a retaining member 456. The retaining member 456 is mounted on the actuating member mount 442 of the body 402. The retaining member 456 is partially received in a bore in the actuating member mount 442. In embodiments, the retaining member 456 may comprise a resilient portion of the actuating member mount 442. The retaining member 456 protrudes in a radial direction. That is, the retaining member 456 protrudes in a direction perpendicular to the longitudinal axial direction. The retaining member 456 is arranged to protrude in the open position recess 460 in the open position. The retaining member 456 is arranged to protrude in the closed position recess 462 in the closed position.

The retaining member 456 is arranged to move in a radial direction. In embodiments, the retaining member 456 is arranged to deform in a radial direction. The retaining member 456 is biased radially outwardly. The retaining mechanism 450 is therefore biased into a retention condition when the actuating member 420 is moved into the open position. The retaining mechanism 450 is therefore biased into a retention condition when the actuating member 420 is moved into the closed position.

The retaining member 456 is a ball spring arrangement. That is, the retaining member 456 comprises a coil spring, a spherical member and a stop for retaining the spherical member. The spherical member is formed of nickel-plated steel. Other suitable materials may be used. In another embodiment, the retaining member 456 is a resilient member. The retaining member 456 comprises a contact surface. The contact surface is curved. The contact surface is formed of a material having a relatively low coefficient of friction with the retaining surface 452.

When the retaining member 456 is protruding in the open position recess 460 or the closed position recess 462, the cover mechanism 401 is retained in the open position or the closed position respectively. It will be understood that the term retained by is intended to mean that a certain level of force must be applied to the cover mechanism 401 to move away from the open or closed position, so that the cover mechanism 401 is not unintentionally moved from the open or closed position. In this embodiment, the ends of the cam slots 434 provide a motion limiting stop, so that the cover mechanism 401 is prevented from moving beyond the open position or the closed position. That is, the cover mechanism 401 is only movable between the open position and the closed position.

The retaining surface 452 is configured to bias the cover member 410 towards at least one of the relatively open position and the relatively closed position over the entire range of motion of the cover member between the relatively open position and the relatively closed position. It will be understood that the retaining surface 452 does not necessarily directly contact the cover member 410. Rather, the retaining surface 452 biases the cover member 410 through other components of the cover assembly 400.

An elongate portion 452a of the retaining surface 452 extends between the open position recess 460 and the closed position recess 462. The elongate portion 452a of the retaining surface 452 comprises a channel 454. The channel 454 extends between the open position recess 460 and the closed position recess 462. The retaining member 456 is arranged to travel in the channel 454 between the open position recess 460 and the closed position recess 462. The retaining surface 452 defines a first edge 454a of the channel 454 and a second edge 454b of the channel 454. The retaining member 456 is arranged to abut the first edge and the second edge 454a, 454b.

The first edge and second edge 454a, 454b converge towards a mid-region of the channel 454. That is, the separation of the first edge and the second edge is at a minimum at the mid region of the channel 454. The first edge and second edge diverge towards each end of the channel 454. That is, the separation of the first edge and the second edge is at a maximum adjacent to the open position recess 460 and adjacent to the closed position recess 462. As the retaining member 456 travels from the open position recess 460 or the closed position recess 462 towards the mid region of the channel 454, the retaining member 456 is forced outwards of the channel 454 by the converging edges of the channel 454. The retaining member 456 therefore travels in a radially inwards direction relative to the axis of rotation of the actuating member 420. As the retaining member 456 is biased in a radially outwards direction, the retaining member 456 is urged into the channel 454. The biasing of the retaining member 456 therefore resists movement out of the relatively open position and the relatively closed position and returns the cover mechanism 401 to the relatively open position or the relatively closed position in the absence of external forces.

The operation of the retaining mechanism 450 will be described with relation to movement from the open position to the closed position, but it will be understood that the operation with respect to movement from the closed position to the open position is generally equivalent.

When the cover mechanism 401 is in the open position, the retaining member 456 is received in the open position recess 460. Force applied to the cover mechanism 401 in a counter-clockwise direction is resisted by the ends of the cam slots 434 acting as motion limiting stops. If a small amount of force, such as may result from unintentional contact with the actuating member 420, is applied to the cover mechanism 401 in a clockwise direction, it is resisted by the biasing of the retaining member 456 against the edges of the channel 454. The cover mechanism 401 is therefore retained in the open position.

If a larger amount of force is applied to the cover mechanism 401 in a clockwise direction, such as by a user intentionally rotating the actuating member 420, the retaining member 456 slides along the channel 454 and moves in a radially inwards direction, against the biasing. The spring of the ball spring arrangement is compressed. As the actuating member 420 is rotated, the retaining member 456 travels in the channel 454 towards the mid region of the channel 454. The retaining mechanism 550 is therefore releasable by the user moving the actuating member 420 out of the closed position. When the retaining member 456 passes the mid region of the channel 454, the cover mechanism 401 ceases to be biased towards the open position and begins to be biased towards the closed position.

The retaining mechanism 450 is therefore biased into the open position over a portion of its range of motion adjacent to the open position. The retaining mechanism 450 is biased into the open position over 50% of its range of motion adjacent to the open position. The cover assembly 400 therefore returns to the open position after small deflections, reducing the likelihood of inadvertently opening or partially opening the cover assembly 400.

The operation of the cover mechanism 401 has been described with relation to one retaining member 456 and two recesses 460 and 462. However, the cover mechanism 401 of FIGS. 3 to 5 comprises two retaining members 456, two open position recesses 460 and two closed position recesses 462. The operation of the second retaining member 456, open position recess 460 and closed position recess 462 is identical to that described above. In embodiments, a different number of retaining members, open position recesses and closed position recesses is used. In embodiments, a single recess may operate as a closed position recess in relation to one retaining member and as an open position recess in relation to another retaining member. That is, the ratio of recesses to retaining members may differ from two to one.

In embodiments, the cam mechanism is omitted and the actuating member 420 is connected to the cover member 410 by a gear mechanism acting as a drive mechanism. For example, the actuating member 420 may comprise a gear track on an inner or outer surface of the actuating member 420. The cover mechanism 401 may comprise a gear arranged to be driven by the gear track and rotatably mounted on the body 410. The cover member 410 may comprise a gear track arranged to be driven by the gear.

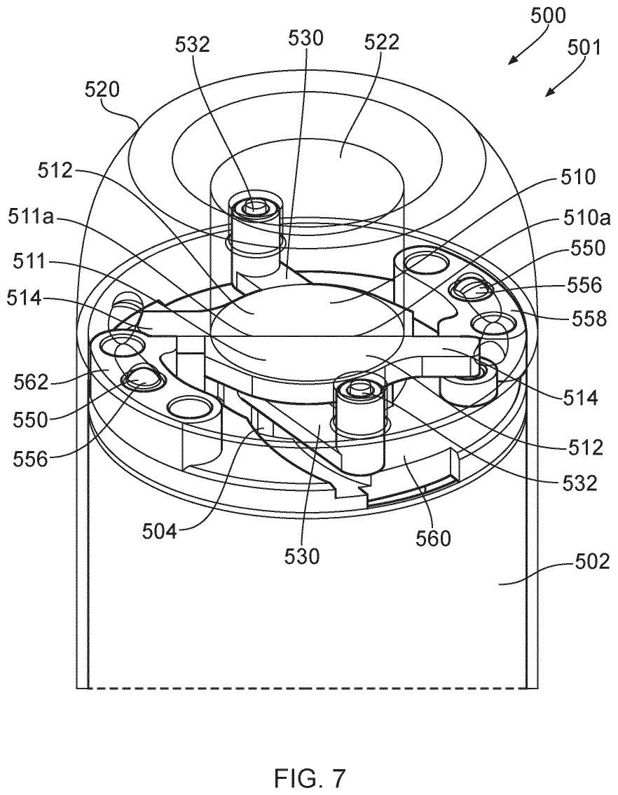

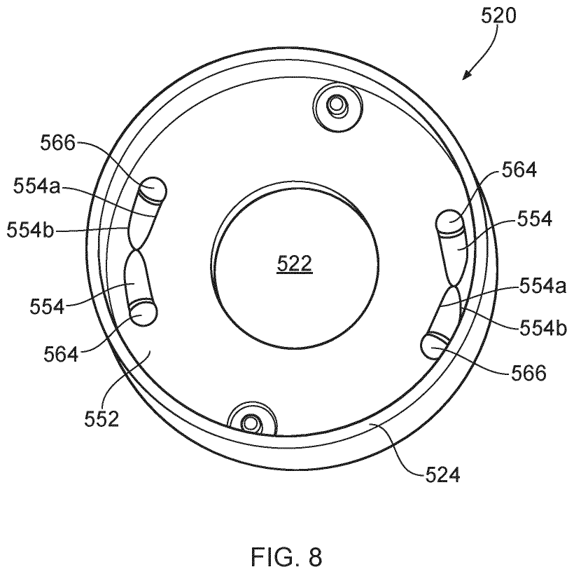

FIG. 7 shows a schematic perspective view of another cover assembly 500 for an aerosol provision device in a closed position and FIG. 8 shows a schematic perspective view from below of an actuating member for the cover mechanism of FIG. 7. Some components are shown transparently to allow for the arrangement of features to be clearly shown and described.

The cover assembly 500 may be used with the aerosol provision device 100 of FIGS. 1 and 2 and will be described by reference to that device. In embodiments, the cover assembly 500 is used with other device arrangements. The cover assembly 500 comprises a cover mechanism 501.

In broad outline, the cover mechanism 501 comprises a body 502, defining the opening 103 of the aerosol provision device, one or more cover members 510, 511 arranged to selectively cover the opening 103 and an actuating member 520. The actuating member 520 is shown in see through in the Figures to clearly show features hidden by the component below. One or more linking members 530 are arranged to move the cover members 510, 511 between a relatively open position in which the at least a portion of an article is able to pass through the opening and a relatively closed position in which the at least a portion of an article is prevented from being able to pass through the opening. The cover members 510, 511 are pivotally attached to the body 502 The actuating member 520 overlies the cover members 510, 511, forming an exterior of the cover mechanism 501. The actuating member 520 is exposed to the exterior of the aerosol provision device 100 and is arranged to be manually actuated by a user.

The cover assembly 500 comprises a body 502. The body 502 is a portion of the main body 101 of the aerosol provision device 100. The body 502 is a rigid member. The body 502 defines part of the housing 102. A seal (not shown) may be provided between the body 502 and other components of the housing 102 of the aerosol provision device 100. The seal may extend around a full peripheral extent of the body 502. In other embodiments, the body 502 may be integrally formed with the housing 102.

The body 502 comprises an opening 504. The opening 504 is the opening 103 of the aerosol provision device 100. The opening 504 communicates with the chamber 105. The opening 504 is dimensioned to receive at least a portion of an article comprising aerosol generating material, such as the article 300.

The cover mechanism 501 of the cover assembly 500 comprises the one or more cover members 510, 511 arranged to selectively cover the opening 504. The cover members 510, 511 co-operate to selectively cover the opening 504. In this embodiment, two cover members 510, 511 are provided. In other embodiments, a different number of cover members may be provided such as one cover member, three cover members, four cover members or substantially any number of cover members.

The cover mechanism 501 comprises a first cover member 510 and a second cover member 511. The first cover member 510 and the second cover member 511 abut one another in the relatively closed position. The first cover member 510 defines a first edge 510a and the second cover member 511 defines a second edge 511a. The first and second edges 510a, 511a are arranged to conform to one another. That is, the first edge 510a and the second edge 511a are profiled to contact one another along their entire length in the relatively closed position.

In embodiments comprising more than two cover members 510, 511, each cover member may comprise a plurality of edges for abutting adjacent cover members 510, 511.

The cover members 510, 511 are mutually interchangeable. That is, the cover members 510, 511 are identical. In other embodiments, the cover members 510, 511 may differ from one another.

The description will proceed by reference to a single cover member 510, and it will be understood that the other cover member 511 comprises similar or identical features.

The cover member 510 slidably contacts the body 502. The cover member 510 is substantially planar. The cover member 510 comprises a blade portion 512 arranged to at least partially cover the opening 504. In embodiments comprising only a single cover member, the blade portion 512 is arranged to fully cover the opening 504. In embodiments comprising two cover members, each cover member, as shown in FIG. 7, is arranged to cover half of the opening 504, and so together fully cover the opening 504. These proportions may differ.

The cover member 510 comprises an arm portion 514. The arm portion 514 extends from the blade portion 520. The arm portion 514 overlaps the body 502 in both the relatively open position and the relatively closed position. The arm portion 514 may therefore be described as an overlap portion. The blade portion 520 and the arm portion 514 are integrally formed. In other embodiments, the blade portion 520 and the arm portion 514 are separate components in a fixed relationship.

The cover member 510 comprises a lower pivot pin (not shown), acting as a pivot member. The lower pivot pin extends from the arm portion 514. The lower pivot pin 511 is spaced from the blade portion 520. The lower pivot pin is received in a bore in the body 502. The cover member 510 is therefore pivotally attached to the body 502. In other embodiments, the body 502 may comprise a pin and the cover member 510 may comprise a bore for receiving the pin.

In embodiments, the cover member 510 may comprise an upper pivot pin acting as a pivot member, instead of or in addition to the lower pivot pin. In such embodiments, the body 502 may comprise an upper portion and a lower portion between which the cover member 510 is held. One of the upper and lower pivot pins may be omitted. The upper pivot pin extends from the arm portion 514. The upper pivot pin is spaced from the blade portion 520. The upper pivot pin extends from an opposite side of the arm portion 514 to the lower pivot pin. The upper pivot pin and lower pivot pin are co-axial. The upper pivot pin and lower pivot pin extend parallel to the longitudinal axial direction.

The cover member 510 is a one-piece component. The cover member 510 is integrally formed. In other embodiments, the cover member 510 may be a composite component formed of multiple parts. For example, the upper pivot pin and the lower pivot pin may be a single pin extending through the arm portion 514.

The cover mechanism 501 comprises the actuating member 520. The actuating member 520 is rotatably mounted on the body 502. The actuating member 520 is operable to selectively actuate the cover members 510, 511. The actuating member 520 is exposed to the exterior of the aerosol provision device 100. The actuating member 520 is arranged to be manually operated by a user to actuate the cover members 510, 511.

The actuating member 520 is a substantially annular member. The actuating member 520 defines an aperture 522. The aperture 522 is centrally disposed in the actuating member 520. The aperture 522 may be omitted. The aperture 522 overlies the opening 504 of the body 502. The aperture 522 is axially aligned with the opening 504 of the body 502. The aperture 522 therefore communicates with the heating zone 107.

The actuating member 520 is arranged to rotate on the body 502 to actuate the cover members 510, 511. The actuating member 520 covers part of the body 502. That is, a portion of the body 502 extends in the actuating member 520. The axis of rotation of the actuating member 520 is parallel with the longitudinal axis of the chamber 105. In embodiments, the axis of rotation is transverse or perpendicular.

The body 502 comprises an actuating member mount (not shown). The actuating member 520 is rotatably engaged with the actuating member mount. The actuating member mount substantially limits movement of the actuating member 520 relative to the body to rotational movement. The actuating member 520 comprises a locating feature (not shown) in engagement with the actuating member mount. The locating feature is a ridge or other suitable feature circumferentially extending around an inner surface of the actuating member 520.

The actuating member mount comprises a clip (not shown) acting as a retention arrangement. The clip is resilient. The actuating member mount may comprise a plurality of clips.

The cover members 510, 511 are disposed between the body 502 and the actuating member 520. The cover members 510, 511 are in sliding contact with the body 502. The cover members 510, 511 are in sliding contact with the actuating member 520. Such an arrangement helps restrict ingress of debris.

Rotation of the actuating member 520 relative to the body 502 causes the cover members 510, 511 to move between a relatively open and a relatively closed position. The linking members 530 link the cover members 510, 511 to the actuating member 530 to enable this movement as described in detail below. The cover assembly 500 is configured to be selectively operated between a relatively open position and a relatively closed position. Such positions are relative to each other. In the relatively open position, at least a portion of the article 300 is able to pass through the opening 504. In the relatively closed position, the at least a portion of the article 300 is prevented from being able to pass through the opening 504.

The term relatively open position will be understood to mean any position in which at least a portion of the article 300 is able to pass through the opening, i.e. including a fully open position and intermediate positions which leave enough space for the portion of the article 300 to be inserted. The term relatively closed position will be understood to mean any position in which the portion of the article 300 is prevented from being able to pass through the opening 504, i.e. including a fully closed position and intermediate positions in which there is not enough space for the article 300 to pass through the opening.

In this embodiment, in the relatively open position, the cover members 510, 511 are free from an overlap with the opening.

In this embodiment, rotation of the actuating member 520 relative to the body 502 causes the cover members 510, 511 to move to or from a fully closed position. The term fully closed position will be understood to mean that the cover members 510, 511 fully closes the opening 504. The terms open and closed as applied to features of the cover mechanism 501 are herein described in relation to one another.

The cover members 510, 511 are arranged to pivot relative to the body 502. The cover members 510, 511 are arranged to pivot in a direction perpendicular to an axis of rotation of the actuating member 520. The axis of rotation of the actuating member 520 is parallel with a longitudinal axis of the chamber. Movement of the cover members 510, 511 between the relatively open position and the relatively closed position is therefore a rotation of the cover members 510, 511. In other embodiments, such movement may additionally or alternatively comprise translation, that is, linear movement.

The cover mechanism 501 comprises the plurality of linking members 530. The linking members 530 link the cover members 510, 511 to the actuating member 520. The linking members 530 provide a mechanical linkage between the cover members 510, 511 and the actuating member 520. In this embodiment, the cover mechanism 501 comprises one linking member 530 for each cover member 510, 511. That is, the cover mechanism 501 comprises two linking members 530. In other embodiments, the ratio of linking member 530 to cover members 510, 511 may be different. For example, two linking members may be provided for each cover member 510, 511.

The linking members 530 are identical. In other embodiments, the linking members 530 may differ from one another. The description will proceed by reference to a single linking member 530, but it will be understood that the other linking member 530 comprises similar or identical features.

The linking member 530 is pivotally attached to the actuating member 520. The linking member 530 pivots about a fixed point on the actuating member 520. In embodiments, the linking member 530 comprises a pin 532 which is received in a bore in the actuating member 520. In other embodiments, the actuating member 520 comprises a pin which is received in a bore in the linking member 530. In other embodiments, both the linking member 530 and the actuating member 520 comprise bores and a separate pin is provided received in both bores.

The linking member 530 is pivotally attached to the cover member 510. The linking member 530 is pivotally attached to an underside of the cover member 510.

The linking member 530 pivots about a fixed point on the cover member 510. In embodiments, the linking member 530 comprises a pin (not shown) which is received in a bore in the cover member 510. In other embodiments, the cover member 510 comprises a pin which is received in a bore in the linking member 530. In other embodiments, both the linking member 530 and the cover member 510 comprise bores and a separate pin is provided received in both bores.

The linking member 530 is free from linear translation relative to the cover member 510. The linking member 530 is free from linear translation relative to the actuating member 520. That is, the linking member 530 is constrained to only rotate relative to each of the actuating member 520 and the cover member 510.

The linking member 530 is an elongate member. The linking member 530 defines a first end and a second end. The linking member 530 is pivotally attached to the actuating member 520 proximal to the first end. The linking member 530 is pivotally attached to the cover member 510 proximal to the second end.

The linking member 530 is a rod. The linking member 530 is formed of a plastics material. The linking member 530 is formed of polyether ether ketone (PEEK). The linking member 530 is a one-piece component. The linking member 530 is integrally formed.

The linking member 530 is a rigid member. This enables the linking member 530 to push the cover member 510 as well as pull the cover member 510. This enables the linking member 530 selectively to cause movement of the cover member 510 in both a first direction and a second direction.

The linking member 530 is pivotally attached to the blade portion 512 of the cover member 510. The cover member 510 defines a first end and a second end. The linking member 530 is pivotally attached to the cover member 510 proximal to the first end and the cover member 510 is pivotally attached to the body 502 proximal to the second end.

The linking member 530 is pivotally attached to the cover member 510 at a point proximal to the point of attachment of the cover member 510 to the body 502. This provides a relationship whereby movement of the linking member 530 produces larger movement of the blade portion of the cover member 510. This reduces the range of motion required of the actuating member and provides a spatially efficient arrangement.

The body 502 comprises a raised portion 558. The raised portion 558 is raised relative to a recess 560 of the body 502. The recess 560 accommodates the cover members 510, 511 and the linking members 530. The opening 504 is provided in the recess 560. The raised portion 558 is a first raised portion and the body 502 comprises a second raised portion 562. The second raised portion 562 may be similar or identical to the first raised portion 558. The second raised portion 562 may be joined to the first raised portion 558 or separated from the first raised portion 558. That is, the first and second raised portions 558, 562 may be portions of a single continuous raised portion. The recess 560 is defined between the first raised portion 558 and the second raised portion 562.

Rotation of the actuating member 520 relative to the body 502 causes the movement of the cover members 510, 511 via the linking members 530. As the actuating member 520 is rotated by the user, the linking members 530 cause the cover members 510, 511 to move between the relatively open position and the relatively closed position.

The cover members 510, 511 are movable between the closed position as shown in FIG. 7 and the open position. Rotating the actuating member 520 clockwise, as shown in the Figures, causes the cover members 510, 511 to move towards the closed position. Rotating the actuating member 520 counter clockwise, as shown in the Figures, causes the cover members 510, 511 to move towards the open position. In other embodiments, these directions may be reversed. In embodiments, the cover mechanism 501 comprises a lubricant.

The cover assembly 500 comprises a retaining mechanism 550. The retaining mechanism 550 is arranged to releasably retain the actuating member 520 in each of the open position and the closed position. In embodiments, the retaining mechanism 550 is arranged to act in one of the open and closed position only.

The actuating member 520 comprises a retaining surface 552. The retaining mechanism 550 comprises an open position recess 564 and a closed position recess 566. The recesses 564, 566 are defined by the retaining surface 550. The retaining surface 552 is an annular surface of the actuating member 520. That is, the retaining surface 552 comprises the aperture 522 of the actuating member 520. The retaining surface 552 is a lower surface of the actuating member 520. That is, the retaining surface 552 faces the body 502 of the cover mechanism. The actuating member 520 comprises a circumferential wall surrounding the retaining surface 552.

The retaining mechanism 550 comprises a retaining member 556. The retaining member 556 is mounted on the raised portion 558 of the body 502. The retaining member 556 is partially received in a bore in the raised portion 558. In embodiments, the retaining member 556 may comprise a resilient portion of the raised portion 558. The retaining member 556 protrudes in the axial direction X of the aerosol provision device 100. The retaining member 556 protrudes in a direction parallel to the axis of rotation of the actuating member 520, henceforth referred to as the axial direction. The retaining member 556 is arranged to protrude in the open position recess 564 in the open position. The retaining member 556 is arranged to protrude in the closed position recess 562 in the closed position.

Because the retaining member 556 protrudes in the axial direction, a more spatially efficient arrangement of the components of the aerosol provision device 100 is possible. For example, a width of the aerosol provision device 100 in a direction perpendicular to the axial direction X may be reduced. This may allow the aerosol provision device 100 to make more efficient use of space within the housing 102 while retaining a regular external profile, for example a pen, cigar or cigarette-like profile.

The retaining member 556 is arranged to move in the axial direction. In embodiments, the retaining member 556 is arranged to deform in the axial direction.

The retaining member 556 is biased in the axial direction. The retaining member 556 is biased towards the actuating member 520. The retaining member 556 is biased away from the body 502. The retaining mechanism 550 is therefore biased into a retention condition when the actuating member 520 is moved into the open position. The retaining mechanism 550 is therefore biased into a retention condition when the actuating member 520 is moved into the closed position.

The retaining member 556 is a ball spring arrangement. That is, the retaining member 556 comprises a coil spring, a spherical member and a stop for retaining the spherical member. The spherical member is formed of nickel-plated steel. Other suitable materials may be used. In another embodiment, the retaining member 556 is a resilient member. The retaining member 556 comprises a contact surface. The contact surface is curved. The contact surface is formed of a material having a relatively low coefficient of friction with the retaining surface 552.

When the retaining member 556 is protruding in the open position recess 564 or the closed position recess 566, the cover mechanism 501 is retained in the open position or the closed position respectively. It will be understood that the term retained by is intended to mean that a certain level of force must be applied to the cover mechanism 501 to move away from the open or closed position, so that the cover mechanism 501 is not unintentionally moved from the open or closed position. In this embodiment, the raised portions of the body 558, 562 provide a motion limiting stop, so that the cover mechanism 501 is prevented from moving beyond the open position or the closed position. That is, the cover mechanism 501 is only movable between the open position and the closed position.

The retaining surface 552 is configured to bias the cover members 510, 511 towards at least one of the relatively open position and the relatively closed position over substantially the entire range of motion of the cover members 510, 511 between the relatively open position and the relatively closed position. It will be understood that the retaining surface 552 does not necessarily directly contact the cover members 510, 511. Rather, the retaining surface 552 biases the cover members 510, 511 through other components of the cover assembly 500.

The retaining surface 552 comprises a channel 554 extending between the open position recess 564 and the closed position recess 566. In embodiments, the channel 554 may be discontinuous or continuous. The channel 554 follows a part-circular arc. The channel 554 extends between the open position recess 564 and the closed position recess 566. The retaining member 556 is arranged to travel in the channel 554 between the open position recess 564 and the closed position recess 566. The retaining surface 552 defines a first edge 554a of the channel 554 and a second edge 554b of the channel 554. The retaining member 556 is arranged to abut the first edge and the second edge 554a, 554b.

The first edge and second edge 554a, 554b converge towards a mid-region of the channel 554. That is, the separation of the first edge and the second edge is at a minimum at the mid region of the channel 554. In this embodiment, the first edge 554a and second edge 554b join at the mid-point of the channel. In other embodiments, the first edge 554a and the second edge 554b do not join. The first edge 554a and second edge 554b diverge towards each end of the channel 554. That is, the separation of the first edge 554a and the second edge 554b is at a maximum adjacent to the open position recess 564 and adjacent to the closed position recess 566. As the retaining member 556 travels from the open position recess 564 or the closed position recess 566 towards the mid region of the channel 554, the retaining member 556 is forced outwards of the channel 554 by the converging edges 554a, 554b of the channel 554. The retaining member 556 therefore travels in the axial direction towards the body 502 and away from the actuating member 520. As the retaining member 556 is biased in the axial direction, the retaining member 556 is urged into the channel 554. The biasing of the retaining member 556 therefore resists movement out of the relatively open position and the relatively closed position and returns the cover mechanism 501 to the relatively open position or the relatively closed position in the absence of external forces.

The operation of the retaining mechanism 550 will be described with relation to movement from the open position to the closed position, but it will be understood that the operation with respect to movement from the closed position to the open position is generally equivalent.

When the cover mechanism 501 is in the open position, the retaining member 556 is received in the open position recess 564. Force applied to the cover mechanism 501 in a counter-clockwise direction is resisted by contact between the cover members 510, 511 and the raised portions 558, 562 of the body 502. If a small amount of force, such as may result from unintentional contact with the actuating member 520, is applied to the cover mechanism 501 in a clockwise direction, it is resisted by the biasing of the retaining member 556 against the edges 554a, 554b of the channel 554. The cover mechanism 501 is therefore retained in the open position.

If a larger amount of force is applied to the cover mechanism 501 in a clockwise direction, such as by a user intentionally rotating the actuating member 520, the retaining member 556 slides along the channel 554 and moves in the axial direction away from the actuating member 520 and towards the body 502, against the biasing. The spring of the ball spring arrangement is compressed. As the actuating member 520 is rotated, the retaining member 556 travels in the channel 554 towards the mid region of the channel 554. The retaining mechanism 550 is therefore releasable by the user moving the actuating member 520 out of the closed position. When the retaining member 556 passes the mid region of the channel 554, the cover mechanism 501 ceases to be biased towards the open position and begins to be biased towards the closed position.

The retaining mechanism 550 is therefore biased into the open position over a portion of its range of motion adjacent to the open position. The retaining mechanism 550 is biased into the open position over 50% of its range of motion adjacent to the open position. The cover assembly 500 therefore returns to the open position after small deflections, reducing the likelihood of inadvertently opening or partially opening the cover assembly 500.

The operation of the cover mechanism 501 has been described with relation to one retaining member 556 and two recesses 564 and 566. However, the cover mechanism 501 of FIGS. 3 to 5 comprises two retaining members 556, two open position recesses 564 and two closed position recesses 566. The operation of the second retaining member 556, open position recess 564 and closed position recess 566 is identical to that described above. In embodiments, a different number of retaining members, open position recesses and closed position recesses is used. In embodiments, a single recess may operate as a closed position recess in relation to one retaining member and as an open position recess in relation to another retaining member. That is, the ratio of recesses to retaining members may differ from two to one.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device comprising:
a body having an opening;
a chamber in the body arranged to receive at least a portion of an article comprising aerosol generating material inserted through the opening; and
a cover mechanism comprising:
a cover member arranged to selectively at least partially cover the opening; and
an actuating member arranged to rotate on the body to actuate the cover member;
wherein rotation of the actuating member relative to the body causes the cover member to move between a relatively open position in which the at least a portion of an article is able to pass through the opening and a relatively closed position in which the at least a portion of an article is prevented from being able to pass through the opening, and
wherein the opening is offset from an axis of rotation of the actuating member.

2. The aerosol provision device of claim 1, wherein the opening is radially spaced from the actuating member.

3. The aerosol provision device of claim 1, wherein the opening is free from an overlap of the actuating member in a plane perpendicular to the axis of rotation of the actuating member.

4. The aerosol provision device of claim 1, wherein the cover member is pivotally attached to body.

5. The aerosol provision device of claim 1, wherein the cover member is arranged to pivot about a pivot point radially spaced from the actuating member.

6. The aerosol provision device of claim 1, wherein the cover mechanism comprises a cam mechanism acting between the cover member and the actuating member.

7. (canceled)

8. The aerosol provision device of claim 1, wherein the actuating member comprises a peripheral wall; the cover member comprises a first arm and a second arm and a recess between the first arm and the second arm arranged to accommodate the peripheral wall.

9. The aerosol provision device of claim 8, wherein the first arm is pivotally attached to the body and wherein the second arm is in engagement with the actuating member.

10. The aerosol provision device of claim 1, comprising a user interface configuration on the actuating member.

11. An aerosol provision device comprising:
a body;
a chamber in the body arranged to receive at least a portion of an article comprising aerosol generating material;
the body having an opening communicating with the chamber; and
a cover mechanism comprising:
a cover member arranged to selectively at least partially cover the opening;
an actuating member arranged to rotate on the body to actuate the cover member; wherein rotation of the actuating member relative to the body causes the cover member to move between a relatively open position in which the at least a portion of an article is able to pass through the opening and a relatively closed position in which the at least a portion of an article is prevented from being able to pass through the opening; and
a retaining mechanism arranged to releasably retain the cover member in at least one of the relatively open position and the relatively closed position;
wherein the actuating member comprises a retaining surface;
wherein the retaining mechanism comprises a retaining member biased against the retaining surface and arranged to slide along the retaining surface; and
wherein the retaining surface is configured to bias the cover member towards at least one of the relatively open position and the relatively closed position over at least substantially the entire range of motion of the cover member between the relatively open position and the relatively closed position.

12. The aerosol provision device of claim 11, wherein the opening is radially spaced from the actuating member and wherein the retaining member and the cover member overlap in a direction parallel to the axis of rotation of the actuating member.

13. The aerosol provision device of claim 11, wherein the opening is radially spaced from the actuating member; and comprising a cam mechanism acting between the actuating member and the cover member; and wherein the retaining member and the cam mechanism overlap in a direction parallel to the axis of rotation of the actuating member.

14. The aerosol provision device of claim 11, wherein the opening is radially spaced from the actuating member; and comprising a cam mechanism acting between the actuating member and the cover member; and wherein the retaining member is radially spaced from the cam mechanism.

15. The aerosol provision device of claim 11, wherein the body comprises a mount received within the actuating member and wherein the retaining member is on or in to the mount.

16. An aerosol provision device comprising:
a body;
a chamber in the body arranged to receive at least a portion of an article comprising aerosol generating material;
the body having an opening communicating with the chamber; and
a cover mechanism comprising:
a cover member arranged to selectively at least partially cover the opening;
an actuating member arranged to rotate on the body to actuate the cover member; wherein rotation of the actuating member relative to the body causes the cover member to move between a relatively open position in which the at least a portion of an article is able to pass through the opening and a relatively closed position in which the at least a portion of an article is prevented from being able to pass through the opening; and
a retaining mechanism arranged to releasably retain the cover member in at least one of the relatively open position and the relatively closed position;
wherein the actuating member defines a channel;
wherein the retaining mechanism comprises a retaining member arranged to travel at least partially in the channel as the actuating member is moved, the retaining member being biased relative to the channel; and
wherein the channel is configured to bias the cover member towards at least one of the relatively open position and the relatively closed position over at least part of the range of motion of the cover member between the relatively open position and the relatively closed position.

17. (canceled)

18. (canceled)

19. (canceled)

20. An aerosol provision device comprising:
a body defining an opening;
a heating zone arranged to receive at least a portion of an article comprising aerosol generating material inserted through the opening; and
a cover mechanism comprising:
a cover member arranged to selectively at least partially cover the opening;
an actuating member arranged to rotate on the body to actuate the cover member; wherein rotation of the actuating member relative to the body causes the cover member to move between a relatively open position in which the at least a portion of an article is able to pass through the opening and a relatively closed position in which the at least a portion of an article is prevented from being able to pass through the opening; and
a retaining mechanism arranged to releasably retain the cover member in at least one of the relatively open position and the relatively closed position;
wherein the actuating member comprises a retaining surface;
wherein the retaining mechanism comprises a retaining member biased in a direction parallel to the axis of rotation of the actuating member against the retaining surface and arranged to slide along the retaining surface; and
wherein the retaining surface is configured to bias the cover member towards at least one of the relatively open position and the relatively closed position.

21. The aerosol provision device of claim 20, wherein the retaining member is in a fixed relationship with the body.

22. The aerosol provision device of claim 20, wherein the retaining surface is in a fixed relationship with the actuating member.

23. The aerosol provision device of claim 20, wherein the cover member is a first cover member and wherein the cover mechanism comprises a second cover member arranged to selectively at least partially cover the opening in co-operation with the first cover member, wherein rotation of the actuating member relative to the body causes the second cover member to move between a relatively open position in which the at least a portion of an article is able to pass through the opening and a relatively closed position in which the at least a portion of an article is prevented from being able to pass through the opening.

24. The aerosol provision device of claim 20, wherein the cover mechanism comprises one or more linking members pivotally attached to the or each cover member respectively and pivotally attached to the actuating member.

25. (canceled)

26. (canceled)

27. (canceled)

28. (canceled)

29. (canceled)

30. (canceled)

31. An aerosol provision system comprising the aerosol provision device of claim 1 and an article comprising aerosol generating material.
